(19) United States
(12) Patent Application Publication
(10) Pub. No.: US 2009/0303704 A1
(43) Pub. Date: Dec. 10, 2009

(54) ILLUMINATED TOY BALLOON WITH STAND

(75) Inventor: Michael L. Schrimmer, Vernon Hills, IL (US)

Correspondence Address: Levenfeld Pearlstein, LLC;Intellectual Property Department, 2 North LaSalle, Suite 1300, Chicago, IL, 60602, US

(73) Assignee: CHEMICAL LIGHT, INC., Vernon Hills, IL (US)

(21) Appl. No.: 12/537,644

(22) Filed: Aug. 7, 2009

Related U.S. Application Data
(63) Continuation-in-part of application No. 12/032,876, filed on Feb. 18, 2008.
Application No. 12/032,876 is a continuation of application No. 10/904,486, filed on Nov. 12, 2004, now Pat. No. 7,344,267.

(51) Int. Cl. F21L 4/02

(52) U.S. Cl. 362/184; 362/189

(57) ABSTRACT

An apparatus for illuminating the interior of a balloon, and a support for the apparatus and the balloon. The illuminating apparatus includes a plug with an integrally-formed radially extending flange insertable within the balloon neck. A hollow filler tube depends from the flange. A light element is affixed to the plug and disposed within the neck. A battery is electrically connected to the light element. Switching is provided to turn the lighting element on and off. A rigid support is operably connected to the inflator and is insertable into the ground to provide an upstanding orientation of the balloon when filled with a lighter-than-air gas or with air.

### CROSS-REFERENCE TO RELATED APPLICATION DATA

This application is a continuation-in-part of U.S. patent application Ser. No. 12/032,876, filed Feb. 18, 2008, which is a continuation of U.S. patent application Ser. No. 10/904,486, filed Nov. 12, 2004, now U.S. Pat. No. 7,344,267.

### BACKGROUND OF THE INVENTION

The present invention relates to illuminated toy balloons. More particularly, the present invention relates to self-supporting illuminated balloons. The use of lights in association with balloons is well known. Examples include U.S. Pat. Nos. 6,390,651 and 5,215,492. Also well known is the use of chemiluminescent materials or light sticks that produce light by chemical reaction which may be inserted into balloons.

The present invention is an improvement over the prior art in which an inexpensive, self-powered apparatus is inserted into the neck of a balloon, which contains a small, energy-efficient light source powered by a battery, and which has the ability to switch on and off.

While such illuminated balloons are known, there is no present way in which such balloons are self-supporting.

Accordingly, there is a need for an illuminated balloon in which the illuminating apparatus is inserted in the balloon, the balloon then filled with a gas such as helium or air, switched on or off as desired, and which is self-supporting.

### SUMMARY OF THE INVENTION

A combination includes an illuminated inflator for inserting into the neck of a toy balloon and a support for the inflator and balloon. The inflator includes a gastight plug having a center and upper and lower ends. A hollow filler tube has upper and lower ends and extends through the center of the plug, with the lower end of the hollow filler tube extending below the lower end of the plug.

A stop valve is in flow communication with the hollow filler tube and is disposed in the plug. A light assembly includes a battery and at least one light element electrically connected to the battery affixed in proximity to the stop valve. The inflator is inserted into the toy balloon with the plug in the neck of the balloon and the bottom of the hollow filler tube extending below the neck of the balloon for filling the balloon with a gas through the hollow filler tube. The stop valve prevents gas from escaping the balloon and the balloon can float freely in the air without support.

A rigid support is operably connected to the inflator at one end and is insertable into the ground at the other end. The support provides an upstanding orientation of the balloon when filled with a lighter-than-air gas or with air. The ground insertion portion of the support can include a pointed, stake-like end on the support. Alternately, a flange can be mounted to a lower end of the rigid support and two pointed, stake-like elements can de[end from the flange to secure the balloon and support in the ground.

The support can be configured so that the stake is inserted into the lower end of the hollow filler tube to provide the rigid connection between the inflator and the support. Alternately, stake has an upper sleeve-like portion and the lower end of the hollow filler tube is inserted into the sleeve-like portion. Preferably, a friction fit is provided between the lower end of the hollow filler tube and the stake. Gripping surfaces can also be provided.

These and other features and advantages of the present invention will be apparent from the following detailed description, in conjunction with the appended claims.

### BRIEF DESCRIPTION OF DRAWINGS

The benefits and advantages of the present invention will become more readily apparent to those of ordinary skill in the relevant art after reviewing the following detailed description and accompanying drawings, wherein:

FIG. 1 depicts a perspective view of a balloon containing the apparatus for illuminating the balloon interior.

FIG. 1A depicts a detail perspective view derived from FIG. 1, showing the apparatus in greater detail.

FIG. 2A depicts a light element assembly containing a battery.

FIG. 2B depicts a perspective view of an embodiment of the apparatus using magnetic means to affix the light element to the plug.

FIG. 3 depicts a perspective view of the embodiment of FIG. 2b, in which the light element assembly is magnetically affixed to the magnet.

FIG. 4A depicts an embodiment of the present invention in which the light element is affixed by means of barbs.

FIG. 4B depicts an embodiment of the present invention in which the light element is affixed by means of restraint fingers.

FIG. 4C depicts an embodiment in which the pressure of gas in the balloon switches on and off the lighting element, in the “off” position.

FIG. 4D depicts an embodiment in which the pressure of gas in the balloon switches on and off the lighting element, in the “on” position.

FIG. 5A depicts a prior-art balloon inflation device in cross section elevation view.

FIG. 5B depicts a prior-art balloon inflation device in top plan view.

FIG. 6A depicts a final embodiment of a lighted balloon inflation device in cross section elevation view.

FIG. 6B depicts a final embodiment of a lighted balloon inflation device in top plan view.

FIG. 7 illustrates an embodiment of the lighted balloon with a ground support.

FIG. 7a illustrates an alternate embodiment of the spike portion of the ground support.

FIG. 8 illustrates alternate embodiment of the ground support.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, nor should be inferred to limit the subject matter disclosed herein.

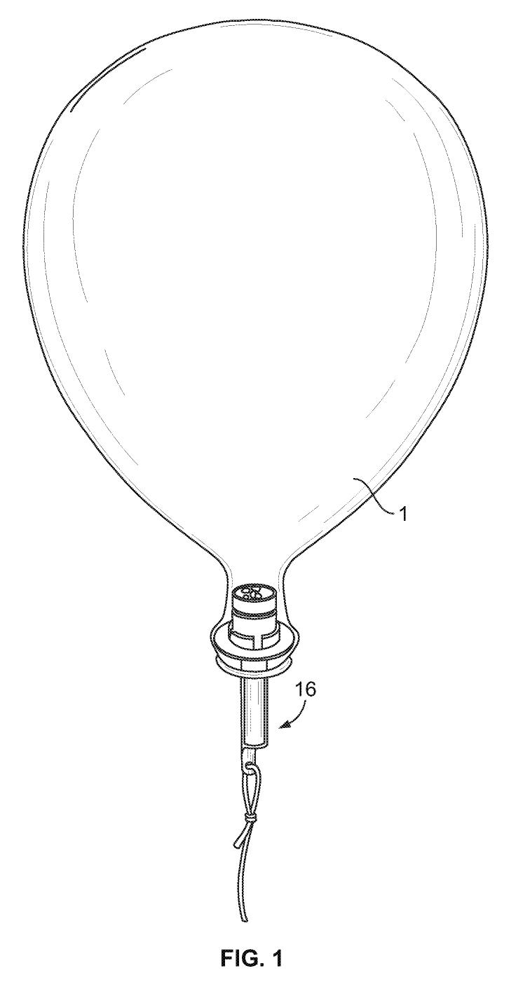

Referring to FIG. 1, the present device 16 is inserted into the neck of a balloon, with a cord 3 attached to the device restraining the balloon. The balloon is obviously filled with a gas, which may be air, helium, or similarly inert gasses, in the case of balloons used as toys, on account of safety concerns. In other applications, where sufficient safeguards are taken, the gas need not be inert.

Referring now to FIG. 1A, the details of this device are revealed. The device, in the form of a plug, contains a cylindrical body 3 which has an integrally formed radially extending flange 7 which retains the device within the balloon. When the device is inserted into the neck 14 of the balloon, the flange 7 causes the neck to provide a gas-tight seal just above the neck ring 15 at the lower end of the neck, which provides stability for the balloon with the device inserted.

Still referring to FIG. 1A, a light-emitting assembly is shown disposed above the flange 7. The assembly is made up of the light emitting surface 13, which is rigidly affixed to a screw-on cap 12, which attaches to the lower assembly housing 11. A battery which powers the light-emitting assembly is contained within the lower housing and screw-on cap. The user may turn the light on and off by screwing the cap down, and conversely screwing the cap in the opposite direction, relieving pressure and disconnecting power to the light element.

In the embodiment shown in FIG. 1A the light-emitting assembly is restrained in place by guides 8. Also contained in this embodiment is a magnet, not shown in this view, which is disposed below the base of the light-emitting assembly.

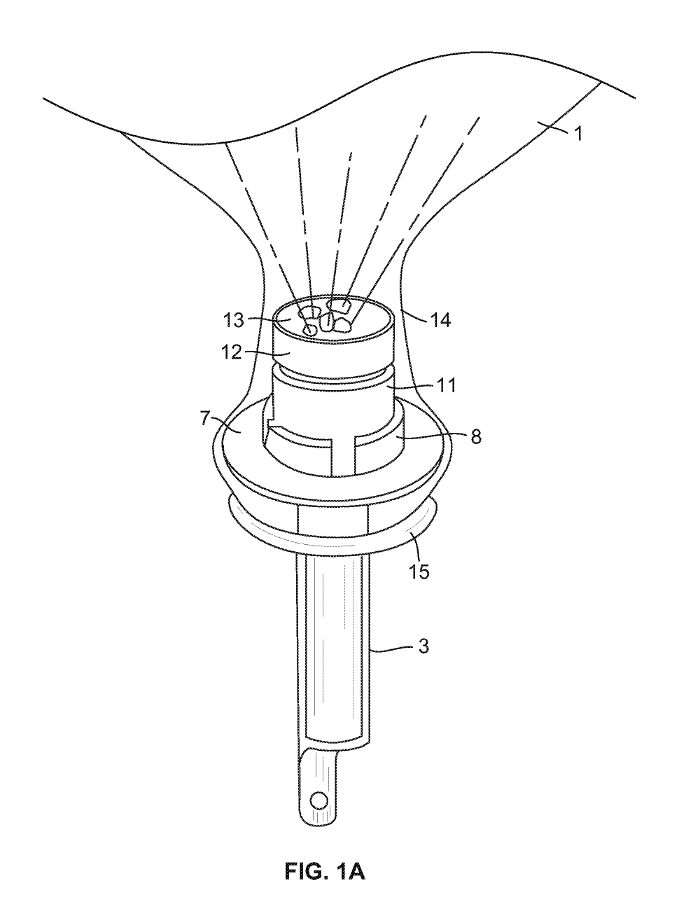

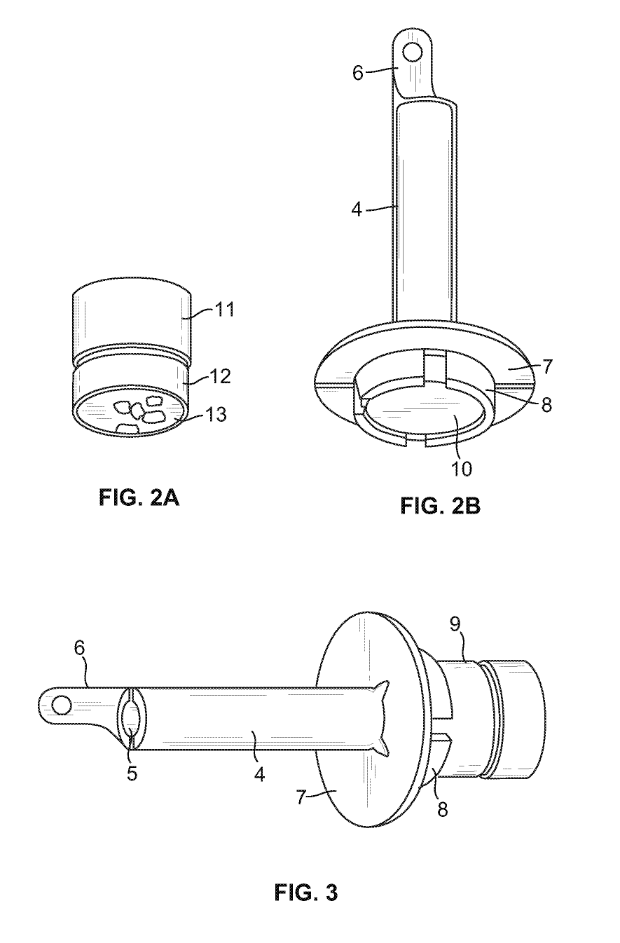

The use of the magnet in this embodiment may be further understood by referring next to FIGS. 2A, 2B, and 3. FIGS. 2A and 2B depict the light-emitting assembly separated from the rest of the device. The battery 12, is clearly displayed in this figure, disposed entirely within the guides 8, and concentrically disposed directly upon the flange 7. FIG. 3 shows the two elements combined to form the device prior to insertion into the balloon. Still referring to these figures, the light-emitting assembly is mounted on the flange between the guides 8, and restrained in place by the magnet 10, which attracts the steel body of the light-emitting assembly 9. The body 4 of the device is in the form of a tube, or cylinder, which is hollow, containing a cylindrical chamber 5 and ending in a tab 6, which provides a hole to which a cord may be attached.

In order to use the device, the balloon may first be filled, typically with helium, so that the balloon floats in the air. In one embodiment the balloon is first filled with helium by means well known in the prior art, and which are not a part of this invention. The user pinches off the neck to retain the helium within the balloon, and then quickly inserts the device into the neck of the balloon. Once the insertion has been accomplished, the flange 7 provides a seal so that the helium will not escape from the balloon, except at a very, very slow rate.

In another variation of this invention, the device may contain a one-way valve, or check valve, permitting the helium to be inserted through the cylindrical chamber 5, but not allowing the helium to escape back through the chamber. In this embodiment the valve is located in the body of the device. Ports (not shown) are provided between the valve and the head of the device to allow the helium to enter the balloon, but not escape.

In this embodiment the device is first inserted into the balloon neck, as shown in FIG. 1, before filling. The helium gas is then pumped in through the cylindrical channel 5 of the body 4, which allows the balloon to fill, until the gas is shut off, relieving the pressure in the channel, and causing the check valve to shut off, retaining the pressure within the balloon indefinitely.

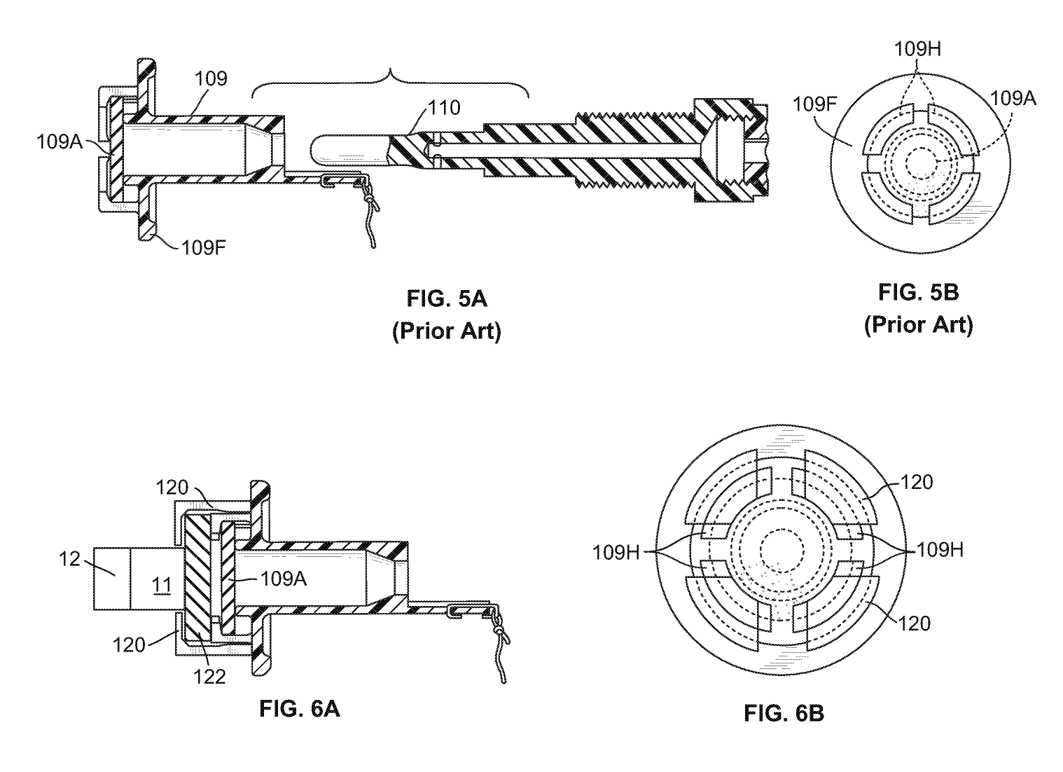

The prior art describes and claims a device such a one-way valve in Zeyra, U.S. Pat. No. 4,167,204. Referring now to FIGS. 5A and 5B a basic valve in accordance with said patent is shown. The head 109 of this prior art device contains the radial flange 109F used for the same purpose as in the present patent. The check-valve effect is accomplished by means of the circular resilient disc 109A. The gas is introduced by means of the filler element 110 which is inserted into the head 109, creating pressure which forces the circular resilient disk 109A outward against the guides 109F.

In the present invention a check valve mechanism may be inserted into the body of the apparatus in order to effect the same end. Because such check valves are well known in the art, and because they are not part of the present invention, they will not be further described here.

A variation of the prior art filler of FIGS. 5A and 5B is shown in FIGS. 6A and 6B. A seen therein, a magnet 122 is mounted atop the lower cage fingers 109H, and is restrained in place by upper cage fingers 120. In this embodiment the magnet does not affect the operation of the check valve in the head, but provides a means for securely retaining the light-emitting assembly.

When using the filler-type device which also illuminates the inside of the balloon, the device is first inserted into the balloon, and then filled with the helium after insertion. Such a variation has the advantage of minimizing the amount of helium lost when the balloon is first filled and then the device is inserted afterwards.

In all of these embodiments the lighting element itself may be of various types. The preferring lighting element is a light-emitting diode (hereinafter “LED”) because of the availability of many different types of LEDs, available at very low prices, and further because of the extremely high efficiency and low power drain on the battery caused by the LED. Among the variations commercially available are LEDs which blink, which change color, and combinations of these two effects.

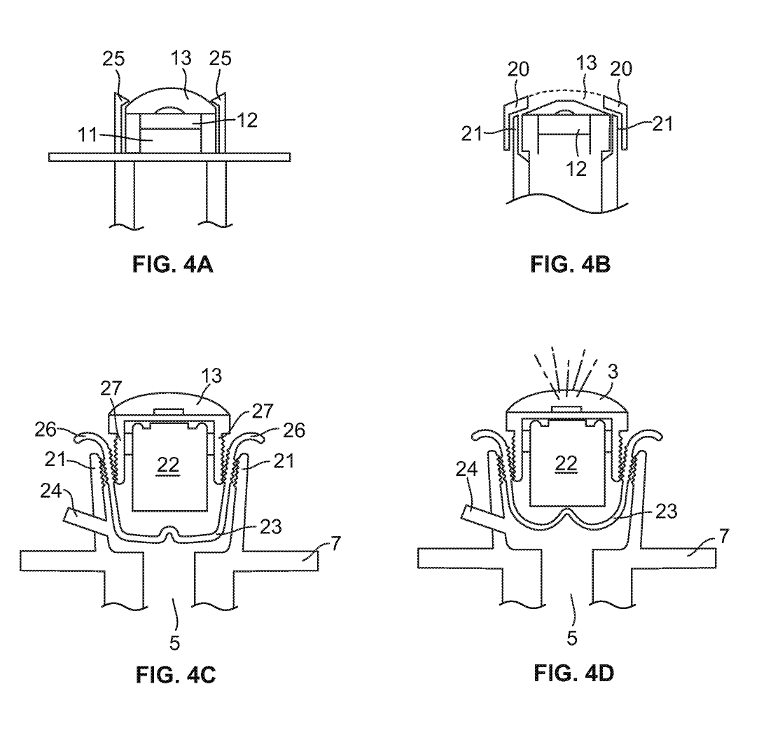

In addition to the magnetic mounting embodiment, many different approaches to mounting of the LED are proposed herein as further embodiments. Referring first to FIG. 4A, the assembly holding the light-emitting element 13 is restrained by barbed fingers 25. The embodiment shown in this figure contains a self-contained light-emitting element having its own battery. It is clear that embodiments in which the battery and LED are separate units may also be used.

In FIG. 4B, a retaining ring 20 is force-fit over a mating enclosure 21 which contains the light-emitting element and battery. In a variation of the embodiment of FIG. 4B a screw-on retaining ring mates with mating threads on the enclosure 21.

Alternative versions are proposed herein for the switching of the light element on and off. In the preferred embodiment depicted in FIG. 1A the user must rotate the upper housing 12 relative to the lower housing 11, as previously stated.

In another alternative embodiment, the filling of the balloon with helium is used to switch the light element on. Referring first to FIG. 4C, this embodiment contains a battery 22 which is in permanent electrical contact with positive terminal of the LED assembly 13. Ground connection is made by metallic element 23, which is configured to keep the helium from passing into the balloon. Helium enters the balloon only through the port 24. In FIG. 4C helium has not yet been inserted into the balloon: element 23 blocks the helium from entering the balloon except through port 24. As the helium is first introduced contact element 23 blocks port 24. At this stage the helium will force contact element 23 upwards until contact is made with the negative electrode of the battery, thereby completing the electrical circuit and causing the LED to illuminate, as shown in FIG. 4D. The teeth on mating enclosure 21, contact element arms 26, and light-element arms 27 form a ratchet mechanism, so that the contact element will stay in the position of FIG. 4D once the balloon is filled with helium, which is facilitated as the contact element rises to clear port 24, allowing the gas into the balloon through this route.

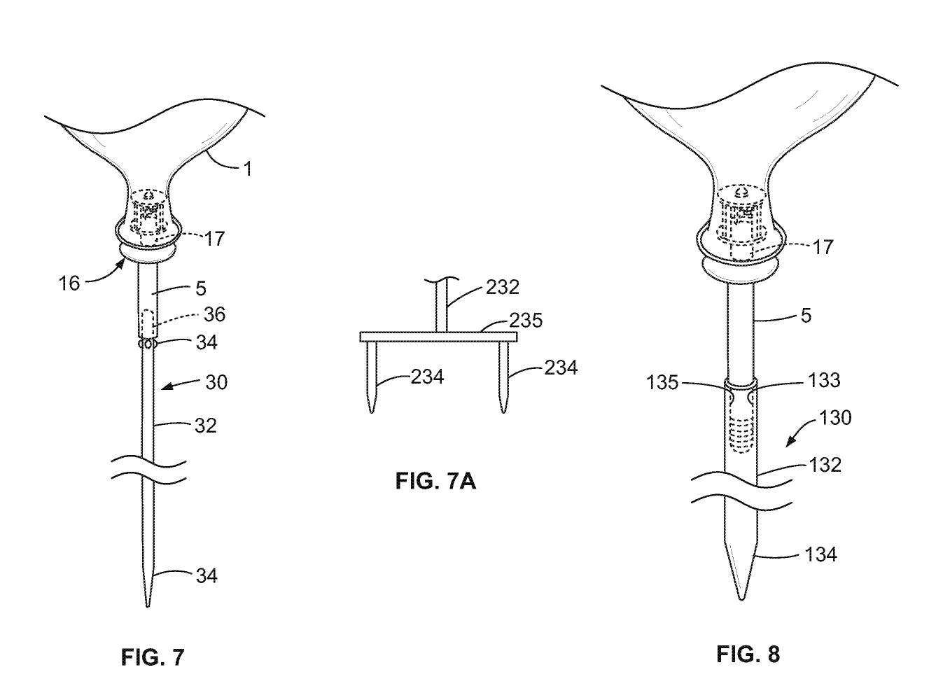

Still other alternate embodiments of an illuminated balloon are illustrated in FIGS. 7 and 8, in which the illuminated balloon is self-supporting. In these embodiments, the cylindrical body 3 is used to inflate the balloon 1 (gas is introduced into the balloon through the chamber 5 and valve 7) and is also used as an attachment location for a supporting stand 30. In such an embodiment, the tab 6 (shown in FIGS. 1 and 1A, but not in FIGS. 7 and 8) may be eliminated as unnecessary.

The stand 30 can be of the type that includes a shaft 32 having a spike-like or pointed end 34 to facilitate insertion into the ground. The connection of the shaft 32 to the illumination device 16 can be made by a variety of configurations. In one configuration, shown in FIG. 7, the shaft 32 is inserted into the opening or chamber 5 in the body 4. Optionally, the shaft 32 can include a stop or interference member 34, such as a projection or flange that prevents over-insertion of the shaft 32 to prevent inadvertently damaging the internal elements in the device 16. The outer surface 36 of the shaft 32 can provide a friction fit of the shaft 32 in the chamber 5 to securely hold the device 16 (and the helium filled balloon 1) to the shaft 32. Alternately, the shaft 32 can be formed having a gripping-enhanced surface, such as flexible fins or the like (not shown), to enhance the holding power of the shaft 32 to the device 16, to, for example, prevent the helium-filled balloon from dislodging from the support 30 and floating away.

Alternately, as seen in FIG. 8, the shaft 132 can include a sleeve 133 into which the body 4 of the device 16 is inserted to secure the device 16 and balloon 1 to the shaft 132. Here, the inner surface 135 of the sleeve 133 can provide a friction fit of the shaft 132 in the sleeve 133 to securely hold the device 16 and the balloon 1; alternately, the sleeve 133 can be formed having a gripping-enhanced surface, such as flexible fins or the like (not shown), to enhance the holding power of the sleeve 133 to the device 16.

The ground insertion portion 34 can be, as discussed above, a single spike-like element. Alternately, as seen in FIG. 7a, multiple spikes 234 can depend from a disk, bar or the like 239 formed at the bottom of the shaft 232, to further enhance securing the stand 30, 130 and the balloon 1 (and device 16) to the ground.

As will be appreciated by those skilled in the art, the connection between the spike 32, 132 or support 30, 130 and the device 16 is a rigid connection. As such, the balloon 1 will be maintained in an upright orientation regardless of whether the balloon 1 is filled with helium (intended to make the balloon float) or filled with air, in which case the balloon 1 may be used as a supported ornament.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present invention. It is to be understood that no limitation with respect to the specific embodiments illustrated is intended or should be inferred.

What is claimed is:

1. In combination, an illuminated inflator for inserting into the neck of a toy balloon and a support for the inflator and balloon, comprising:
a gastight plug having a center and upper and lower ends;
a hollow filler tube having upper and lower ends, the hollow filler tube extending through the center of the plug, with the lower end of the hollow filler tube extending below the lower end of the plug;
a stop valve in flow communication with the hollow filler tube and disposed in the plug;
a light assembly including a battery and at least one light element electrically connected to the battery affixed in proximity to the stop valve, wherein the inflator is inserted into the toy balloon with the plug in the neck of the balloon and the bottom of the hollow filler tube extending below the neck of the balloon for filling the balloon with a gas through the hollow filler tube, and such that the stop valve prevents gas from escaping the balloon can float freely in the air without support; and
a rigid support operably connected to the inflator and insertable into the ground to provide an upstanding orientation of the balloon when filled with a lighter-than-air gas or with air.

2. The combination inflator and support in accordance with claim 1, further comprising a pointed, stake-like end on the support.

3. The combination inflator and support in accordance with claim 1 wherein the stake is inserted into the lower end of the hollow filler tube to provide a rigid connection between the inflator and the support.

4. The combination inflator and support in accordance with claim 3 including a friction fit between the lower end of the hollow filler tube and the stake.

5. The combination inflator and support in accordance with claim 1 wherein the stake has an upper sleeve-like portion and the lower end of the hollow filler tube is inserted into the sleeve-like portion.

6. The combination inflator and support in accordance with claim 5 including a friction fit between the upper sleeve-like portion and the stake.

7. The combination inflator and support in accordance with claim 4 wherein one or both of the lower end of the hollow filler tube and the stake has a gripping surface.

8. The combination inflator and support in accordance with claim 6 wherein one or both of the upper sleeve-like portion and the stake has a gripping surface.

9. The combination inflator and support in accordance with claim including two pointed, stake-like elements mounted to a flange at a lower end of the rigid support.
